(19) United States
(12) Patent Application Publication
(10) Pub. No.: US 2013/0140385 A1
(43) Pub. Date: Jun. 6, 2013

(54) CHARGE INJECTED FLUID ASSIST LIQUID ATOMIZER

(71) Applicants: Nathaniel Robert Demmons, Mason, NH (US); Gavin Gibson McDonald, Santa Barbara, CA (US)

(72) Inventors: Nathaniel Robert Demmons, Mason, NH (US); Gavin Gibson McDonald, Santa Barbara, CA (US)

(73) Assignee: BUSEK CO., INC., Natick, MA (US)

(21) Appl. No.: 13/585,885

(22) Filed: Aug. 15, 2012

Related U.S. Application Data
(60) Provisional application No. 61/575,304, filed on Aug. 17, 2011.

(51) Int. Cl. B05B 5/03

(52) U.S. Cl. CPC B05B 5/03
USPC 239/706

(57) ABSTRACT

A charge injected fluid assist liquid atomizer including a liquid delivery channel, a flow focusing member for generating a coaxial air stream to draw a slender jet from the liquid in the delivery channel toward an opposing orifice, an electrode in the channel submerged in the liquid, and a power source for applying a voltage between the electrode and channel to inject a charge into the liquid entrained in the focused flow of the jet and through the opposing orifice.

### RELATED APPLICATIONS

This application claims benefit of and priority to U.S. Provisional Application Ser. No. 61/575,304 filed Aug. 17, 2011 under 35 U.S.C. §§119. 120, 363, 365, and 37 C.F.R. §1.55 and §1.78 incorporated herein by this reference.

### GOVERNMENT RIGHTS

This invention was made with U.S. Government support under DOD Air Force contract Nos. FA8650-08-M-2894 and FA8650-09-C-2044. The Government may have certain rights in the subject invention.

### FIELD OF THE INVENTION

This subject invention relates to an improved charge injected air assist liquid atomizer such as useful, for example, in chemical reaction processes and combustion engines.

### BACKGROUND OF THE INVENTION

For many applications, it is advantageous to finely atomize liquids to micron or sub-micron sizes. There are various methods to achieve this goal including using high pressure spray orifices or air assisted atomizers. More recent investigations have implemented liquid charging in conjunction with orifice injection and are termed “charge injection”. In such a device, an electrode is submerged in the working fluid immediately upstream of a small orifice. When voltage is applied current flows between the submerged electrode and an opposing electrode; however, due to the liquid flow some or all of the injected charge is expelled out of the orifice with the liquid. This injected charge then impacts liquid jet breakup, reducing liquid ligand size, which in turn reduces ultimate droplet sizes produced but still yields fairly large droplets in the range of 35-50 mμ.

One type of air assist liquid atomizer is known as a “flow focusing” atomizer. Flow focusing (FF) involves the use of a convergent coaxial gas stream to draw a slender jet from a free meniscus at the end of a tube. The convergent gas stream exits through a hole in the opposing plate near the bubble of liquid. The gas flow causes the liquid to elongate towards the hole. Once the applied pressure drop overcomes the surface tension of liquid exiting the feed tube, a jet is formed at the maximum point of curvature on the surface of the liquid. The jet is then drawn through the hole with the gas. Once through the plate the pressure becomes nearly constant, and as a result the jet diameter does not change significantly. At some point downstream capillary instability begins, and jet breakup commences. In these approaches the breakup results in still fairly large and non-uniform in droplet sizes as well as chaotic or non-uniform depression patterns. Typically fairly high pressures and voltages are required.

### SUMMARY OF THE INVENTION

In accordance with various aspects of the subject invention in at least one embodiment the invention presents an improved, charge injected, fluid assist liquid atomizer which reduces droplet size, produces better, more uniform droplet dispersion and less tendency to reagglomerate, and enables better control of droplet size, voltage and pressure as well as post-atomization phase and droplet manipulation.

The subject invention results from the realization that, in part, an improved charge injected fluid assist liquid atomizer in various aspects can be achieved by an electrode submerged in the liquid in a liquid delivery channel to draw a slender jet of liquid toward an opposing orifice and injecting a charge from the electrode into the liquid entrained in the jet through the opposing orifice.

This invention features a charge injected fluid assist liquid atomizer including a liquid delivery channel, a flow focusing member for generating a coaxial air stream to draw a slender jet from the liquid in the delivery channel toward an opposing orifice, an electrode in the channel submerged in the liquid, and a power source for applying a voltage between the electrode and channel to inject a charge into the liquid entrained in the focused flow of the jet and through the opposing orifice.

In a preferred embodiment the liquid delivery channel may include a tubular passage. The flow focusing member may include an air inlet collar and a converging surface. The opposing orifice may be biased at a different voltage than the electrode. The electrode may extend beyond the end of the channel toward the opposing orifice. The electrode may be shaped to a point at its end toward the opposing orifice. The assist fluid may include air.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a simplified schematic diagram of a charge injected fluid assist liquid atomizer according to one embodiment of this invention;

FIG. 2 is a three dimensional view of a single charge injected fluid assist liquid atomizer according to one embodiment of this invention;

FIG. 3 is a cross-sectional view of the charge injected fluid assist liquid atomizer of FIG. 2;

FIG. 4 is a graph illustrating the wide range of Sauter mean diameter droplet sizes that can be processed and the ease of selection of operating parameters of air pressure and flow rate;

FIGS. 5 and 6 illustrate plume control effected by this invention; and

FIG. 7 is a three dimensional view of a plurality of charge injected fluid assist liquid atomizers fabricated with a stack of multiple, etched plates.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

Charge injection is advantageous when attempting to atomize poorly conducting liquids, such as heavy hydrocarbon fuels. First, adding charge injection to a flow focusing atomizer as shown by the invention reduces the droplet size obtained from the atomizer. This is a result of the added electrostatic forces applied on the thin. charged, liquid jet drawn from the opposing orifice. This reduces jet diameter and the resultant droplets obtained from jet breakup. Second, after the thin jet breaks up into a plume of droplets, the charged droplets are dispersed more readily and are less prone to agglomeration into larger droplets. This is because of the coulombic repulsion between droplets in the plume. Third, injection of charge into the gas-atomized liquid spray enables electrostatic droplet manipulation. Post-atomization manipulation of the droplets is another feature of the invention disclosed here achievable by the added controllability. This invention originated from the desire to finely atomize heavy hydrocarbon fuels (JP-7, JP-8, JP-10, etc . . . ) for improved combustion performance. Non-volatile fuels with low vapor pressures are typically more difficult to bum because they do not readily evaporate on the time scales encountered in combustors. However, if the fuel is atomized into droplets that are a few microns in diameter, they burn more like premixed gases. The reason for this is that once combustion is initiated, heat conduction forward from the flame front fully evaporates the small droplets prior to arrival of the flame front. This results in complete gaseous product combustion, rather than burning droplets.

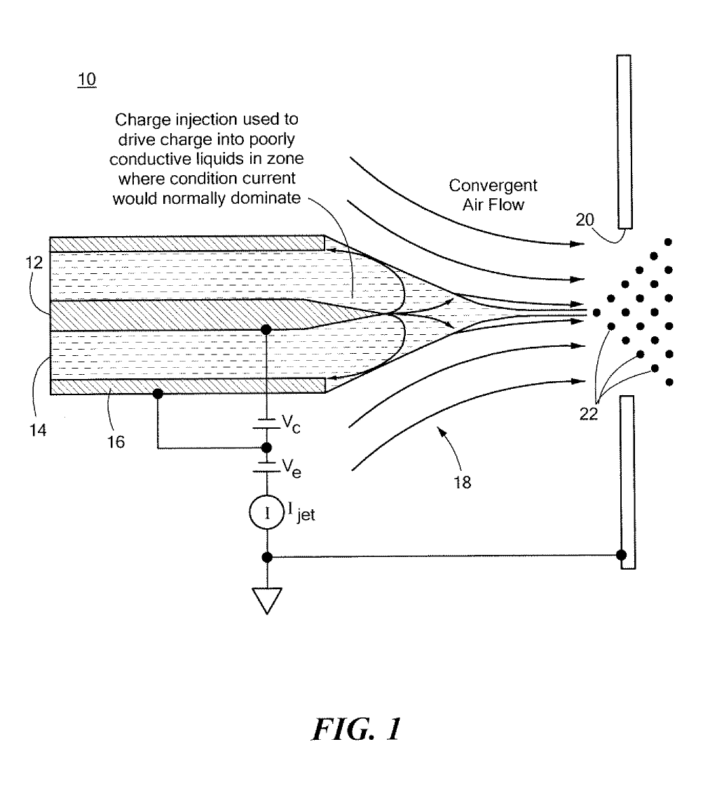

The invention successfully integrates charge injection into a flow focusing atomizer for the purpose of finely atomizing heavy hydrocarbon fuels. The implementation of charge injection reduced droplet size by ˜2% at high (12 psi) atomization gas pressures and higher droplet size reductions were obtained at lower gas pressures (1 psi to 5 psi). In some cases as much as 30%. Furthermore, the addition of charge injection significantly increases fuel spray dispersion, see FIG. 1.

A general schematic of the atomizer of this invention is shown in FIG. 1. In order to integrate charge injection into the air assist atomizer, the capillary supply tube leading to the flow focusing aperture is modified to accept a sharpened annular tungsten electrode. The electrode is electrically isolated from the remainder of the flow focusing body. Fluid channel geometry ensures that the charge injected into the liquid is expelled through the flow focusing stage before reaching the grounded walls of the tube. Electric current measurements indicate that the bulk of the electrical current exits the atomizer with the atomized liquid.

The position of the electrode is adjusted to obtain several microamps of current at potentials of a few thousand volts; however, the charge injection mechanism can be biased further with respect to the grounded atomizer housing. This enables the charge injector to operate at proper voltages, while further electrostatic forces can be applied to the free liquid surface and jet by additional bias voltage. For example Vc=1500V, 500V.

For applications where a liquid fuel is being atomized, the CEFF atomizer has been demonstrated by the inventors to require no more than 3% of the total combustion air to operate. This is advantageous because compression of air to operate the atomizer is a parasitic loss to overall system efficiency.

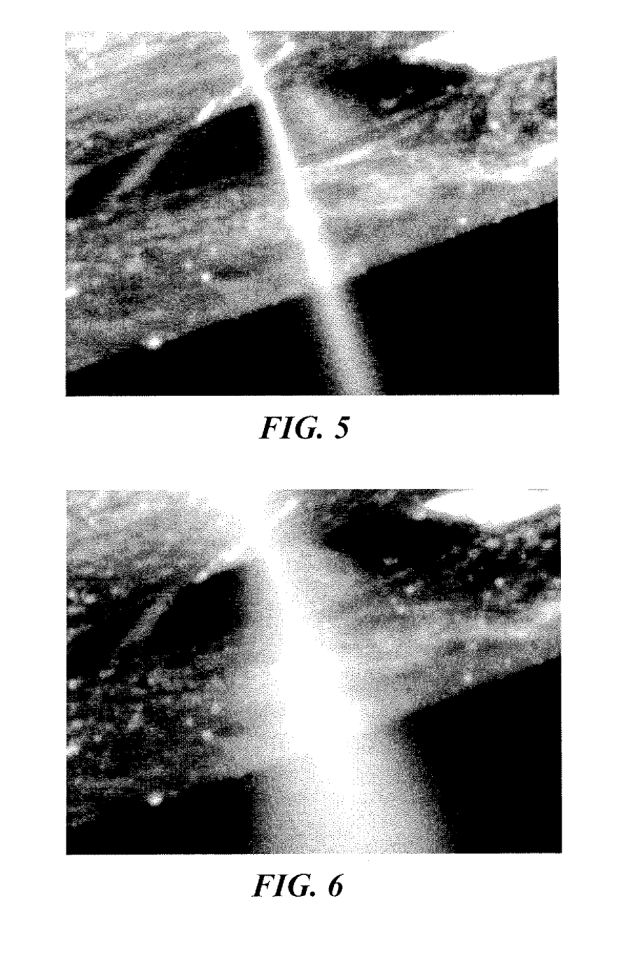

The benefits and functionality of combining charge injection with an air assist atomizer are: reduced droplet size, inhibiting of droplet coalescence. improved spray dispersion, and the added ability to electrostatically manipulate the droplet plume. See FIGS. 5 and 6.

There is shown in FIG. 1 a charge injected fluid assist liquid atomizer 10 featuring the charge enhanced flow focusing. There is a sharpened electrode 12 submerged in the fluid 14 with a voltage difference V_{c} applied between the sharpened electrode and the fluid delivery capillary 16. The convergent gas, for example air 18, draws the fluid through the opposing orifice 20 dragging some of the injected charge with the fluid. The charged jet then breaks up into droplets 22.

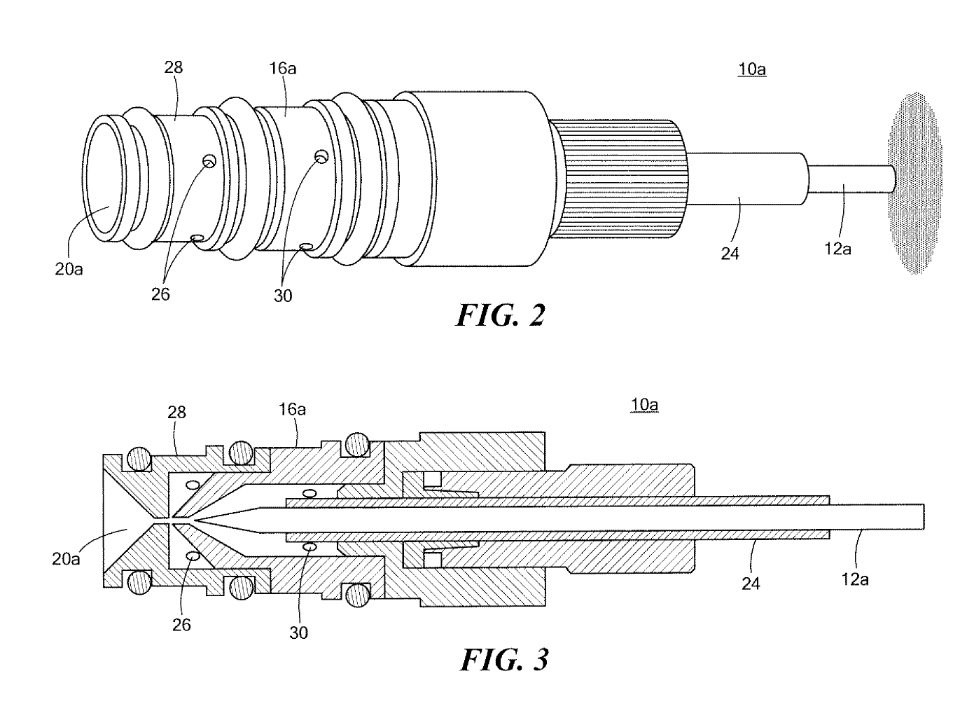

In one embodiment as shown in FIGS. 2 and 3 atomizer 10a includes spray orifice 20a, grounded body 16a, with electrode 12a, surrounded by insulation 24. Air inlets 26 are provided on orifice unit 28 and fuel inlets 30 are provided on grounded body 16a.

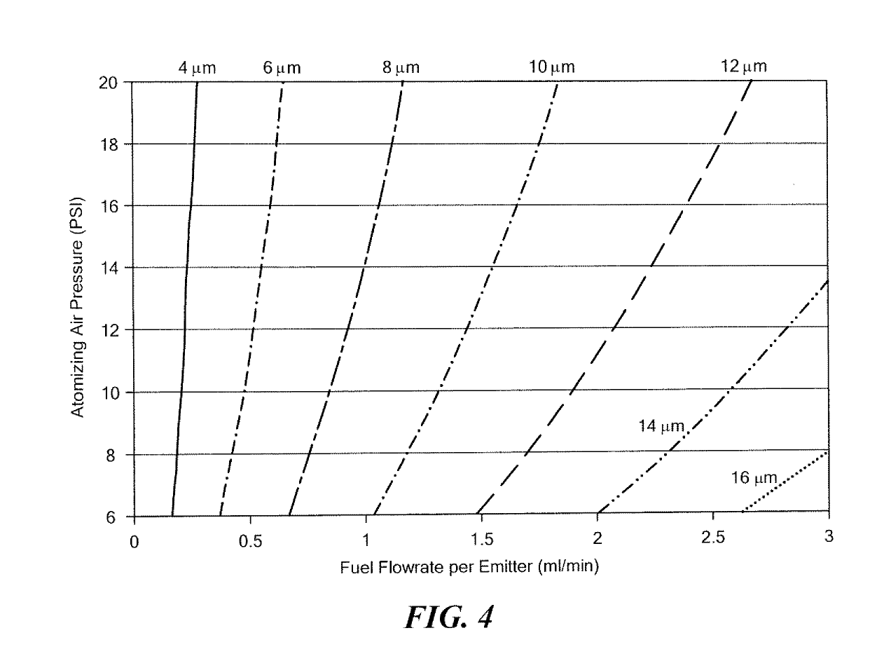

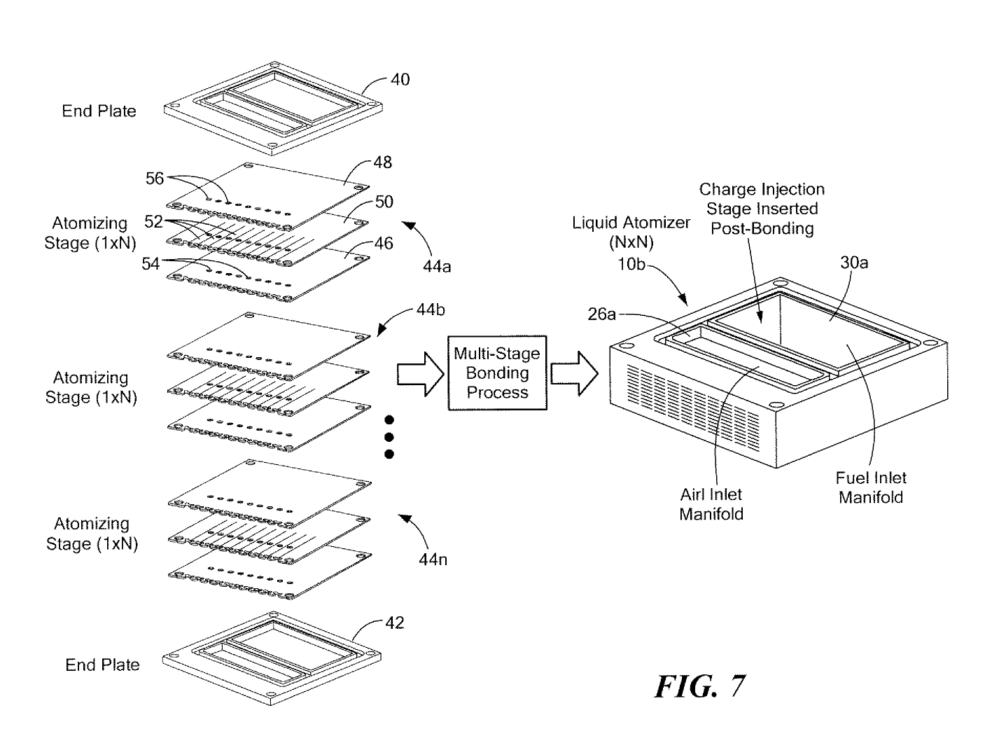

The improved results are depicted in FIG. 4 where the fuel flow rate per emitter millimeters per minute is plotted on the abscissa while the atomizing air pressure and PSI is plotted on the ordinate for JP-8 fuel. The improved atomization and controllability is depicted in the photographs in FIGS. 5 and 6 where FIG. 5 depicts the uncharged atomization and FIG. 6 the charged atomization in accordance with this invention. Although a circularly symmetrical design is shown in FIGS. 1, 2 and 3 this not the only implementation of the invention contemplated. For example, as shown in FIG. 7 the atomizer 10b can be constructed with an air inlet manifold 26a and fuel inlet manifold 30a which is fabricated in a multi-stage bonding process, using a pair of end plates 40, 42 and a number of atomizing stages 44a-44n where each atomizing stage 44a-44n is formed of a base plate 46, cover plate 48, and a channel plate 50 having etched in it a number of channels 52 which are accessed through holes 54 and 56 etched in plates 48 and 46.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

What is claimed is:

1. A charge injected fluid assist liquid atomizer comprising:
a liquid delivery channel;
a flow focusing member for generating a coaxial air stream to draw a slender jet from the liquid in said delivery channel toward an opposing orifice;
an electrode in said channel submerged in said liquid; and
a power source for applying a voltage between said electrode and channel to inject a charge into the liquid entrained in the focused flow of the jet and through the opposing orifice.

2. The charge injected fluid assist liquid atomizer of claim 1 in which said liquid delivery channel includes a tubular passage.

3. The charge injected fluid assist liquid atomizer of claim 1 in which said flow focusing member includes an air inlet collar and a converging surface.

4. The charge injected fluid assist liquid atomizer of claim I in which said opposing orifice is biased at a different voltage than said electrode.

5. The charge injected fluid assist liquid atomizer of claim 1 in which said electrode extends beyond the end of said channel toward said opposing orifice.

6. The charge injected air assist liquid atomizer of claim 1 in which said electrode is shaped to a point at its end toward said opposing orifice.

7. The charge injected air assist liquid atomizer of claim 1 in which said assist fluid includes air.
